(19) United States
(12) Patent Application Publication
(10) Pub. No.: US 2015/0078753 A1
(43) Pub. Date: Mar. 19, 2015

(54) REMOTE CONTROL SYSTEM AND METHOD

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: CHANG-FONG LUNG, New Taipei (TW); JIA SUN, Wuhan (CN)

(21) Appl. No.: 14/484,297

(22) Filed: Sep. 12, 2014

(30) Foreign Application Priority Data
Sep. 13, 2013 (CN) 201310417226.7

(51) Int. Cl. H04B 10/40; G08C 17/02

(52) U.S. Cl. CPC H04B 10/40; G08C 17/02; G08C 2201/50
USPC 398/106; 340/12.22

(57) ABSTRACT

A remote control system is used for remotely controlling controlled devices. The remote control system includes an input device and a data process device. The input device includes a first communication device. The data process device includes a second communication device for communicating with the first communication device, a storage unit storing an identification table, a controller, and a transceiver. The controller determines whether the data process device receives a control signal from the input device, the control signal including an identification of the input device. When receiving the control signal, the controller determines if the identification of the input device is stored in identification table. The controller outputs a code signal corresponding to the control signal if the identification of the input device is stored in the storage unit. The transceiver receives the code signal and transmits the code signal to a specific one of the controlled devices.

### FIELD

The subject matter herein generally relates to remote control technologies, and particularly to a remote control system and method using infrared communication.

### BACKGROUND

Nowadays, home appliances, for example, televisions and air conditioners, are usually controlled by infrared remote controllers. Each home appliance needs a fixed remote controller. If the fixed remote controller is lost, users need to buy a new one.

### BRIEF DESCRIPTION OF THE DRAWINGS

Implementations of the present technology will now be described, by way of example only, with reference to the attached figures, wherein:

FIG. 1 is a block diagram illustrating an embodiment of a remote control system, the remote control system including a data process device for connecting to an input device.

FIG. 2 is a block diagram illustrating an embodiment of the data process device of FIG. 1.

FIG. 3 is a block diagram illustrating a control unit, a storage unit, a first communication device, and a second communication device of the data process device of FIG. 2.

FIG. 4 is a schematic diagram illustrating an interface of a smart input device of FIG. 1.

FIG. 5 is a block diagram illustrating the smart input device of FIG. 1.

FIGS. 6-10 are flowcharts illustrating an embodiment of a remote control method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

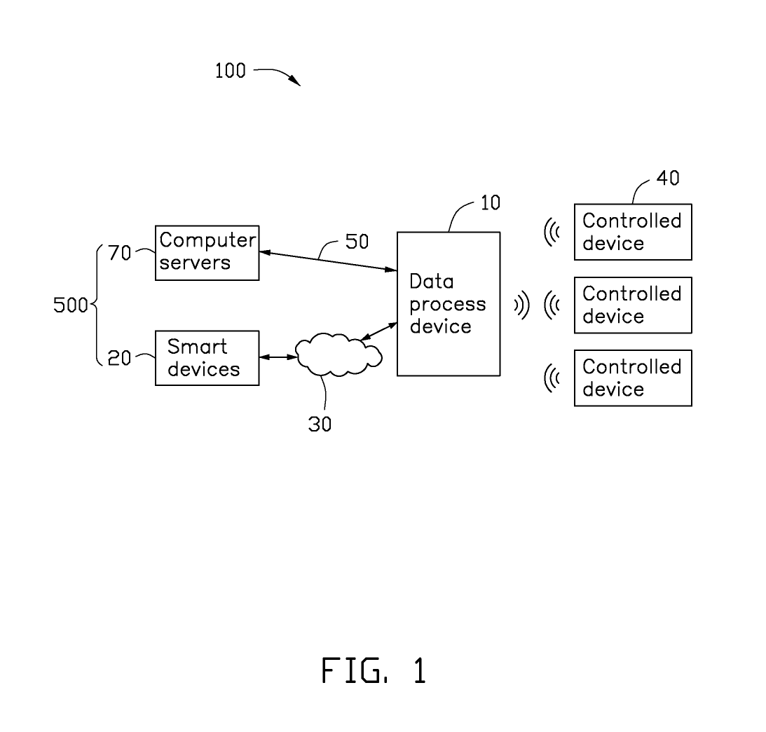

Referring to FIG. 1, an embodiment of a remote control system 100 includes an input device 500, a wireless communication network 30, a cable communication network 50, a data process device 10, and a plurality of controlled devices 40. The data process device 10 can communicate with the input device 500 through the wireless communication network 30 or the cable communication network 50 and can communicate with the controlled devices 40 through infrared communication. In the illustrated embodiment, the input device 500 includes smart devices 20 and computer servers 70. The smart devices 20 can communicate with the data process device 10 through BLUETOOTH communication, near field communication (NFC) or wireless fidelity (Wi-Fi) communication. The computer servers 70 can communicate with the data process device 10 through RJ45 ports, such that the computer severs 70 can communicate with the data process device 10 through the cable communication network 50.

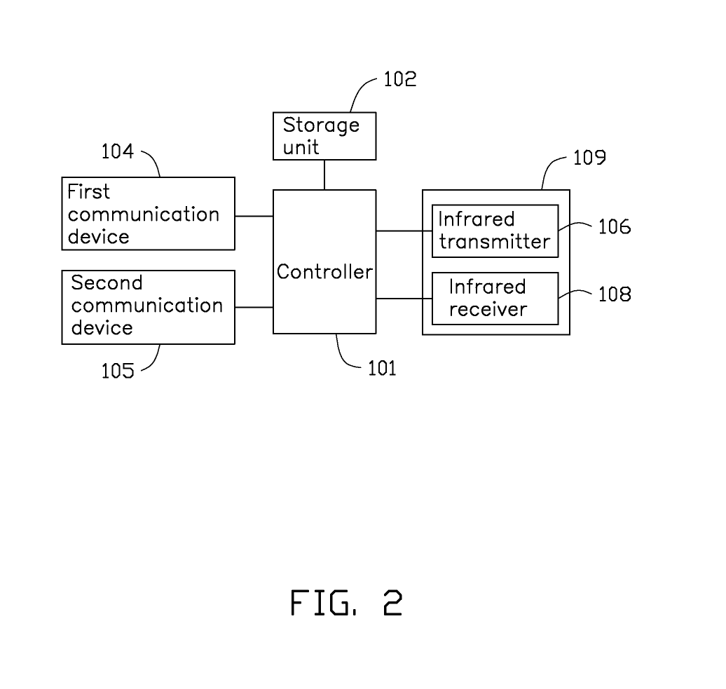

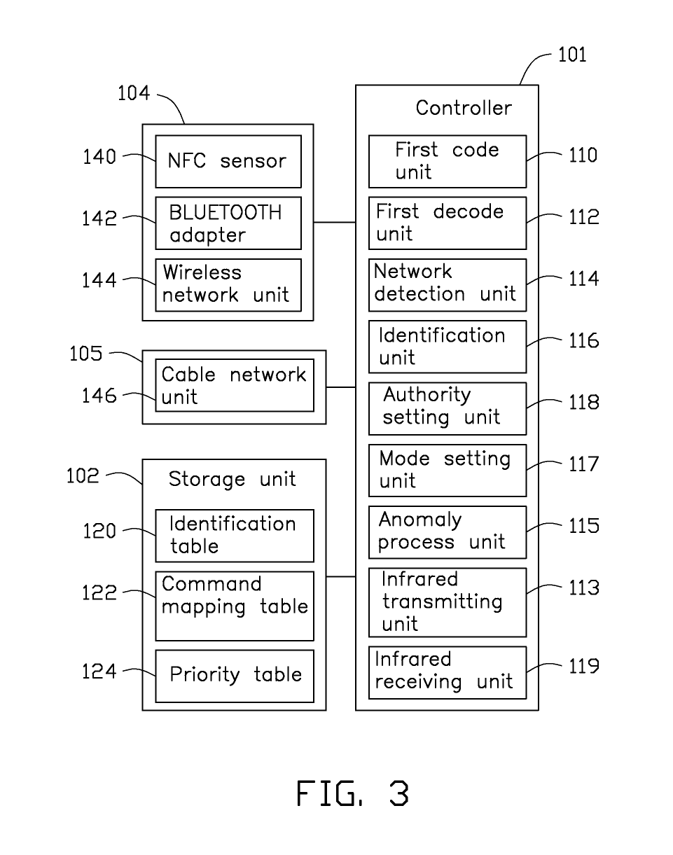

Referring also to FIGS. 2 and 3, the data process device 10 includes a first communication device 104, a second communication device 105, a transceiver 109, a storage unit 102, and a controller 101. The controller 101 is in communication with the first communication device 104, the second communication 105, the transceiver 109 and the storage unit 102. The transceiver 109 includes an infrared transmitter 106 and an infrared receiver 108.

The first communication device 104 is used to communicate with the smart devices 20 through the wireless network 30, and the second communication device 105 is used to communicate with the computer severs 70 through the cable communication network 50. In the illustrated embodiment, the first communication device 104 includes an NFC sensor 140, a BLUETOOTH adapter 142, and a wireless network unit 144. The second communication device 105 includes a cable network unit 146. The input device 500 includes at least one of NFC sensors, BLUETOOTH adapter, wireless network units, and cable network units.

The NFC sensor 140 includes three working modes: card emulation mode, point to point mode, and reader/writer mode. In the card emulation mode, the NFC sensor 140 does not generate a frequent field, while another NFC sensor generates the frequent field and communicates with the NFC sensor 140 when the NFC sensor 140 is in the frequent field. In the point to point mode, the NFC sensor 140 and the another NFC sensor each generate a frequent field, when they are close, they are in communication with each other. In the reader/writer mode, the NFC sensor 140 generates the frequent field, while the another NFC sensor does not generate the frequent field, the another NFC sensor communicates with the NFC sensor 140 when the another NFC sensor is in the frequent field.

The BLUETOOTH adapter 142 communicates with the input device 500 through BLUETOOTH communication. The BLUETOOTH adapter 142 includes two working modes: master mode and slave mode. In the master mode, the BLUETOOTH adapter 142 searches for eligible devices having BLUETOOTH communication units.

The wireless network unit 144 communicates with the input device 500 with wireless fidelity. The wireless network unit 144 includes two working modes: server mode and client mode. In the server mode the wireless network unit 144 can build a wireless hotspot, such that other wireless communication modules in the client mode can connect to the wireless hotspot. In the client mode, the wireless network unit 144 can connect to other wireless hotspots.

The cable network unit 146 communicates with the input device 500 when the cable network unit 146 connects to the input device 500 through cables.

The storage unit 102 stores an identification table 120, a command mapping table 122, and a priority table 124. The identification table 120 stores the identifications of the smart devices 20 and the computer servers 70. The command mapping table 122 stores commands for controlling the controlled devices 40. The priority table 124 stores an identification order for selecting one of the smart devices 20 and the computer servers 70 to connect to the data process device 10. When more than one of the smart devices 20 and the computer servers 70 has a same instruction for a same controlled device 40, the controller 101 selects one of the smart devices 20 and the computer servers 70 having the highest priority to control the controlled device 40 by reading the priority table 124.

The controller 101 includes a first code unit 110, a first decode unit 112, a network detection unit 114, an identification unit 116, an authority setting unit 118, a mode setting unit 117, an anomaly process unit 115, an infrared transmitting unit 113, and an infrared receiving unit 119.

The mode setting unit 117 is used for setting the working mode of the NFC sensor 140, the BLUETOOTH adapter 142, and the wireless network unit 144, for example, setting the NFC sensor 140 to one of the card emulation mode, the point to point mode and the reader/writer mode, setting the BLUETOOTH adapter 142 to one of the master mode and the slave mode, or setting the wireless network unit 144 to one of the server mode and the client mode.

The network detection unit 114 is used to detect whether the data process device 10 can communicate with the input device 500 through the cable communication network 50. When the network detection unit 114 detects that a specific one of the computer servers 70 wants to connect to the data process device 10 through the cable communication network 50, the network detection unit 114 obtains a control signal output by the specific computer server 70, and then the network detection unit 114 outputs a connection signal to the identification unit 116. The control signal and the connection signal each include the identification of the specific computer server 70. In the illustrated embodiment, the network detection unit 114 can output a data request through the cable network unit 146. When the specific computer server 70 communicates with the data process device 10 through the cable communication network 50, the network detection unit 114 receives a response to the data request from the specific computer server 70 and then the network detection unit 114 outputs the connection signal with the identification of the specific computer server 70 to the identification unit 116. If the network detection unit 114 does not receive the response to the data request, it is determined that no computer server 70 connects to the data process device 10.

The network detection unit 114 can also detect whether any of the smart devices 20 are around it. In the illustrated embodiment, the mode setting unit 117 sets the NFC sensor 140 to the point to point mode or the reader/writer mode, sets the BLUETOOTH adapter 142 to the master mode, and sets the wireless network unit 144 to the server mode. And then the network detection unit 114 detects whether any of the smart devices 20 are around it through the NFC sensor 140, the BLUETOOTH adapter 142 and the wireless network unit 144. For example, the NFC sensor 140 works in the reader/writer mode, if the network detection unit 114 detects there is a specific smart device 20 working in the card emulation mode around it, the NFC sensor 140 would obtain the identification of the specific smart device 20. And then the network detection unit 114 outputs a detection signal to the identification unit 116. The detection signal includes the identification of the specific smart device 20.

The identification unit 116 obtains the identification of the specific computer sever 70 through the connection signal and obtains the identification of the specific smart device 20 through the detection signal, and further determines whether the identification of the specific computer sever 70 or the identification of the specific smart device 20 exists in the identification table 120. When the identification of the specific computer sever 70 or the identification of the specific smart device 20 exists in the identification table 120, the identification unit 116 outputs an authentication signal to the network detection unit 114. Otherwise, the identification unit 116 outputs a first abnormal signal to the anomaly process unit 115.

When receiving the authentication signal, the network detection unit 114 communicates with the computer sever 70 or the specific smart device 20. The network detection unit 114 transmits the control signal output from the specific computer sever 70 or the specific smart device 20 to the first decode unit 112. The first decode unit 112 decodes the control signal to obtain a control instruction corresponding to the control signal. The first decode unit 112 obtains a control command response to the control instruction from the command mapping table 122 and outputs the control command to the first code unit 110. In one embodiment, the first decode unit 112 can also transmits the control command to the authority setting unit 118.

The first code unit 110 codes the control command to obtain a code signal and transmits the code signal to the infrared transmitting unit 113.

The infrared transmitting unit 113 transmits the code signal to the infrared transmitter 106, and then the infrared transmitter 106 transmits the code signal to a specific one of the controlled devices 40, such that the specific controlled device 40 performs an action in response to the code signal, for example, the specific controlled device is turned on.

The authority setting unit 118 sets the authorities corresponding to the identifications stored in the identification table 120. When the authority setting unit 118 receives the control command from the first decode unit 112, the authority setting unit 118 determines whether the control command has the authority in response to the identification of the input device 500. When the control command has the authority, the authority setting unit 118 transmits an authority signal to the first code unit 110. The first code unit 110 codes the control command upon a condition that the first code unit 110 receives the authority signal, and then transmits the code signal corresponding to the control command to the specific controlled device 40 through the infrared transmitting unit 113 and the infrared transmitter 106. When the control command does not have the authority, the authority setting unit 118 outputs a second abnormal signal to the anomaly process unit 115.

In one embodiment, the authority setting unit 118 determines whether there are at least two of the smart devices 20 and the computer server 70 communicating with the data process device 10. For example, if receiving at least two control commands, then the authority setting unit 118 determines there are at least two of the smart devices 20 and the computer servers 70 communicating with the data process device 10. If there are at least two of the smart devices 20 and the computer server 70 communicating with the data process device 10, then the authority setting unit 118 further determines whether the data process device 10 is receiving at least two control signals from the at least two of the smart devices 20 and the computer server 70 to control a same controlled device 40. If there are at least two identifications to obtain the control commands for controlling the same controlled device 40, then it is determined that there are at least two of the smart devices 20 and the computer server 70 intending to control the same controlled device 40. And then the authority setting unit 118 determines which one of the smart devices 20 and the computer server 70 has the highest priority from the priority table 124 and transmits the control command from the one of the smart devices 20 and the computer server 70 having the highest priority to the first code unit 110. The first code unit 110 codes the control command from the one of the smart devices 20 and the computer server 70 having the highest priority to obtain a code signal and transmits the code signal to the controlled device 40 through the infrared transmitting unit 113 and the infrared transmitter 106. The authority setting unit 118 can also determine whether the data process device 10 is receiving control commands for controlling the same function of a same controlled device 40 from at least two of the smart devices 20 and the computer server 70. When there are at least two identifications to obtain control commands for controlling the same function of the same controlled device 40, the authority setting unit 118 selects the one of the smart devices 20 and the computer server 70 having highest priority by reading the priority table 124 and transmits the control command corresponding to the identification of the one of the smart devices 20 and the computer server 70 having highest priority to the first code unit 110, and then the first code unit 110 codes the control command into a code signal and transmits the code signal to the controlled device 40 through the infrared transmitting unit 113 and the infrared transmitter 106.

For example, the priority table 124 stores an identification order. In one embodiment, the priority table 124 contains a list of device identifiers. Each device identifier provides an identification of either a specific one of the smart devices 20 or a specific one of the computer servers 70. A device identifier closer to the head of the list identifies a device having higher priority than a device identified by a device identifier further from the head of the list. Therefore the priority table 124 can be searched for the device identifiers of two of the devices in order to determine which of the two devices has a higher priority by a comparison of the locations in the list where the device identifiers are found.

When a specific one of the smart devices 20 connects to the data process device 10, the mode setting unit 117 can change the working mode of the NFC sensor 140, a wireless network unit 144 or the working mode of the BLUETOOTH adapter 142 depending on different demands. For example, when the data process device 10 receives a control signal from the specific smart device 20, the NFC sensor 140 can be set to the card emulation mode and the BLUETOOTH adapter 142 can be set to the slave mode.

When receiving the first abnormal signal from the identification unit 116, the anomaly process unit 115 reminds users through the input device 500 whether to store the identification of the input device 500. When the users decide to store the identification of the input device 500, the anomaly process unit 115 stores the identification of the input device 500 in the identification table 120. When the users decide not to store the identification of the input device 500, the input device 500 outputs a first abnormal information, for example, “the identification cannot be verified.” When receiving the second abnormal signal from the authority setting unit 118, the input device 500 outputs a second abnormal information, for example, “the authority fails to match.”

The infrared receiving unit 119 receives a first state signal about the state of a specific controlled device 40 from the specific controlled device 40 through the infrared receiver 108, and transmits the first state signal to the first decode unit 112. The first decode unit 112 decodes the first state signal to obtain the state of the specific controlled device 40 and transmits the state of the specific controlled device 40 to the first code unit 110. The first code unit 110 codes the state of the specific controlled device 40 into a second state signal and transmits the second state signal to the input device 500.

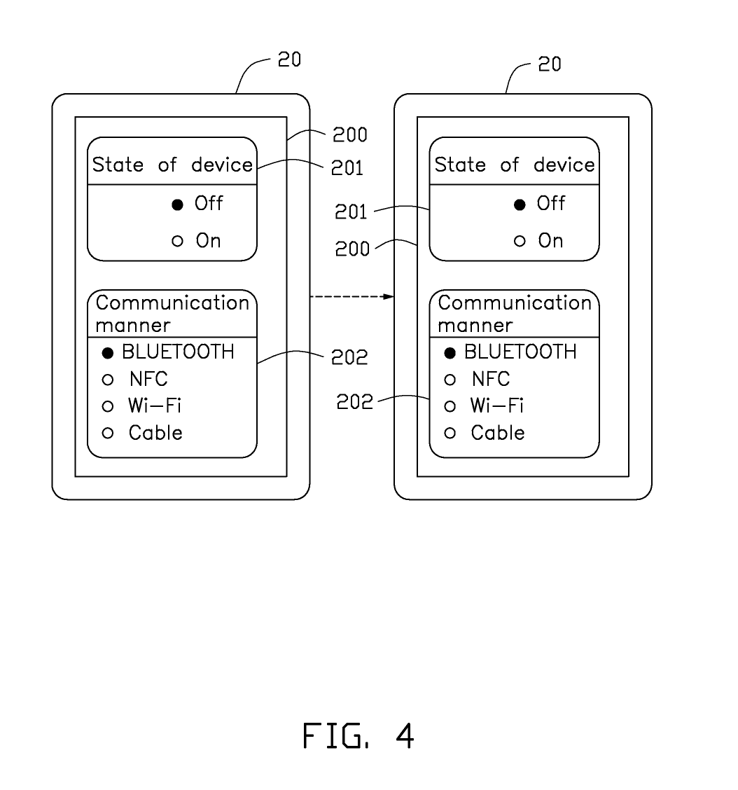

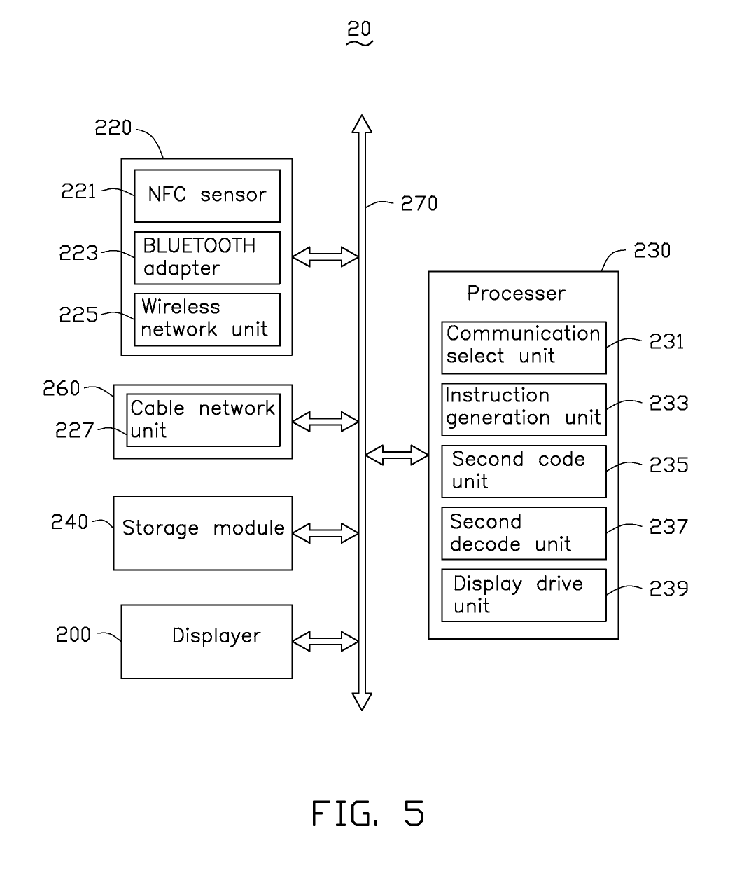

Referring also to FIGS. 4 and 5, the input device 500 includes a displayer 200, a processer 230, a third communication device 220, a fourth communication device 260, and a storage module 240. The displayer 200, the third communication device 220, the fourth communication device 260, and the storage module 240 all connect to the processer 230 through the bus 270.

The third communication device 220 includes an NFC unit 221, a BLUETOOTH unit 223, a wireless communication unit 225. The NFC unit 221, the BLUETOOTH unit 223 and the wireless communication unit 225 all work in slave mode. When the third communication device 220 enters the frequent field generated by the data process unit 10, the third communication device 220 communicates with the first communication device 104.

The fourth communication device 260 includes a cable communication unit 227. The input device 500 communicates with the cable network unit 146 of the second communication device 105 through the cable communication unit 227, so as to transmit the identifications of the input device 500 to the data process device 10 through the cable communication network 50.

The processer 230 includes a communication select unit 231, an instruction generation unit 233, a second code unit 235, a second decode unit 237, and a display drive unit 239.

The display drive unit 239 is used to drive the displayer 200 to display an operation interface. The operation interface can include a state interface 201 displaying the state of the specific controlled device 40, for example, on or off. The operation interface can also include a communication manner interface 202 displaying the communication manner between the input device 500 and the data process device 10, for example, BLUETOOTH, NFC, Wi-Fi or cable.

The communication select unit 231 is used to select the communication manner between the input device 500 and the data process device 10, for example, BLUETOOTH, NFC, or Wi-Fi. In one embodiment, when users select the BLUETOOTH through the communication manner interface 202, the communication select unit 231 selects the BLUETOOTH unit 223 to communicate with the BLUETOOTH adapter 142 of the data process device 10. When the users select NFC, the communication select unit 231 selects the NFC unit 221 to communicate with the NFC sensor 140 of the data process device 10. When the users select Wi-Fi, the communication select unit 231 selects the wireless communication unit 225 to communicate with the wireless network unit 144 of the data process device 10. When the users select cable, the communication select unit 231 selects the cable communication unit 227 to communicate with the cable network unit 146 of the data process device 10.

The instruction generation unit 233 is used to generate an instruction for controlling the controlled devices 40. When the users select the button “On” through the state interface 201, the instruction generation unit 233 generates an instruction for powering the controlled device 40 on.

The second code unit 235 is used to code the instruction generated by the instruction generation unit 233 to obtain the control signal and transmits the control signal to the data process device 10 through the third communication device 220 or the fourth communication device 260.

The second decode unit 237 is used to decode the second state signal from the data process device 10 to obtain the state of the controlled device 40 and further transmits the state of the controlled device 40 to the display drive unit 239. And then the display drive unit 239 drives the displayer 200 to display the state of the controlled device 40, for example, the state interface 201 displays “power off.”

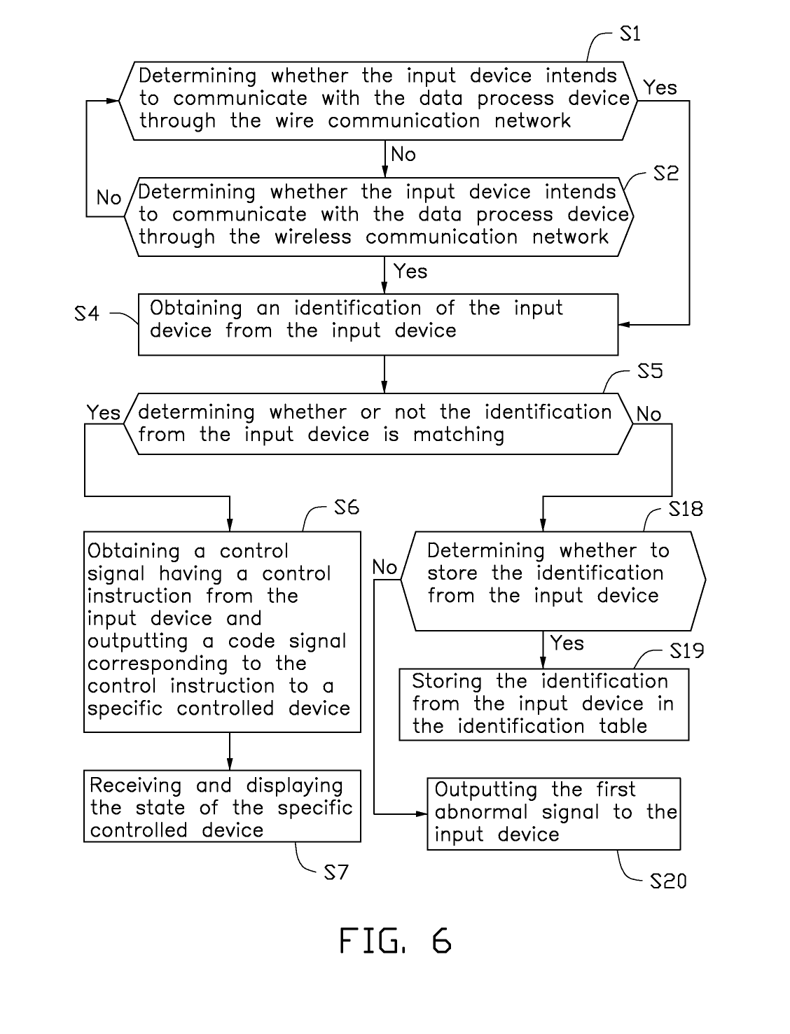

Referring to FIG. 6, one embodiment of a remote control method includes the following steps.

In step S1, the network detection unit 114 determines whether the input device 500 intends to communicate with the data process device 10 through the cable communication network 50. If yes, step S4 is performed; if not, step S2 is performed.

In step S2, the network detection unit 114 determines whether the input device 500 intends to communicate with the data process device 10 through the wireless communication network 30. If yes, step S4 is performed; if not, step S1 is performed.

In step S4, the network detection unit 114 obtains an identification of the input device 500 from the input device 500 and transmits the identification to the identification unit 116.

In step S5, the identification unit 116 determines whether or not the identification from the input device 500 is matching. If not, step S18 is performed; if yes, step S6 is performed. In one embodiment, the identification unit 116 determines if the identification from the input device 500 is stored in the identification table 120. If the identification from the input device 500 is stored in the identification table 120, the identification unit 116 transmits an authentication signal to the network detection unit 114. Otherwise, the identification unit 116 transmits a first abnormal signal to the anomaly process unit 115.

In step S6, the data process device 10 obtains a control signal having a control instruction from the input device 500 and outputs a code signal corresponding to the control instruction to a specific controlled device 40, so as to control the specific controlled device 40. In one embodiment, when receiving the authentication signal from the identification unit 116, the network detection unit 114 obtains the control signal having the control instruction from the input device 500.

In step S7, the input device 500 receives and displays the state of the specific controlled device 40.

In step S18, when the identification of the input device 500 does not exist in the identification table 120, the anomaly process unit 115 receives a first abnormal signal from the identification unit 116 and then outputs a reminder to the input device 500 through the network detection unit 114, so as to remind users whether to store the identification from the input device 500. If the users decide not to store the identification from the input device 500, step S20 is performed; if the users decide to store the identification from the input device 500, step S19 is performed.

In step S19, the anomaly process unit 115 stores the identification from the input device 500 in the identification table 120.

In step S29, the anomaly process unit 115 outputs the first abnormal signal to the input device 500.

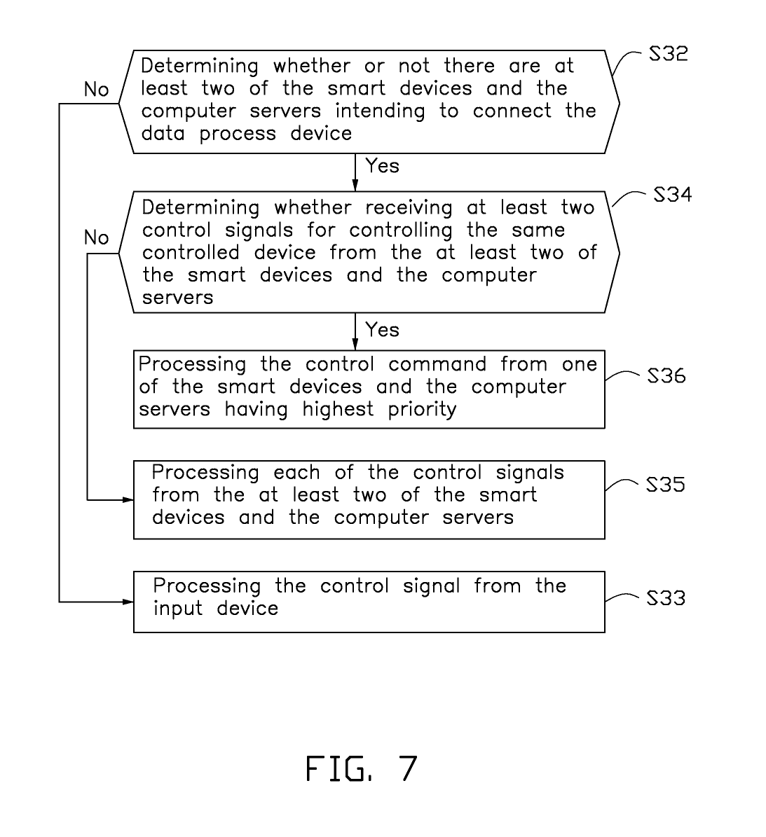

Referring to FIG. 7, in one embodiment, the remote control method further includes the following steps between step S5 and step S6.

In step S32, the authority setting unit 118 determines whether or not there are at least two of the smart devices 20 and the computer servers 70 intending to connect the data process device 10. If yes, step S34 is performed; if not, step S33 is performed.

In step S33, the authority setting unit 18 and the first decode unit 112 process the control signal from the input device 500.

In step S34, the authority setting unit 118 determines whether receiving at least two control commands for controlling the same controlled device 40 from the at least two of the smart devices 20 and the computer servers 70. If yes, step S36 is performed; if not, step S35 is performed.

In step S35, the authority setting unit 118 processes each of the control commands from the at least two of the smart devices 20 and the computer servers 70.

In step S36, the authority setting unit 118 selects one of the smart devices 20 and the computer servers 70 having highest priority from the priority table 124 and processes the control command from the one of the smart devices 20 and the computer servers 70 having highest priority.

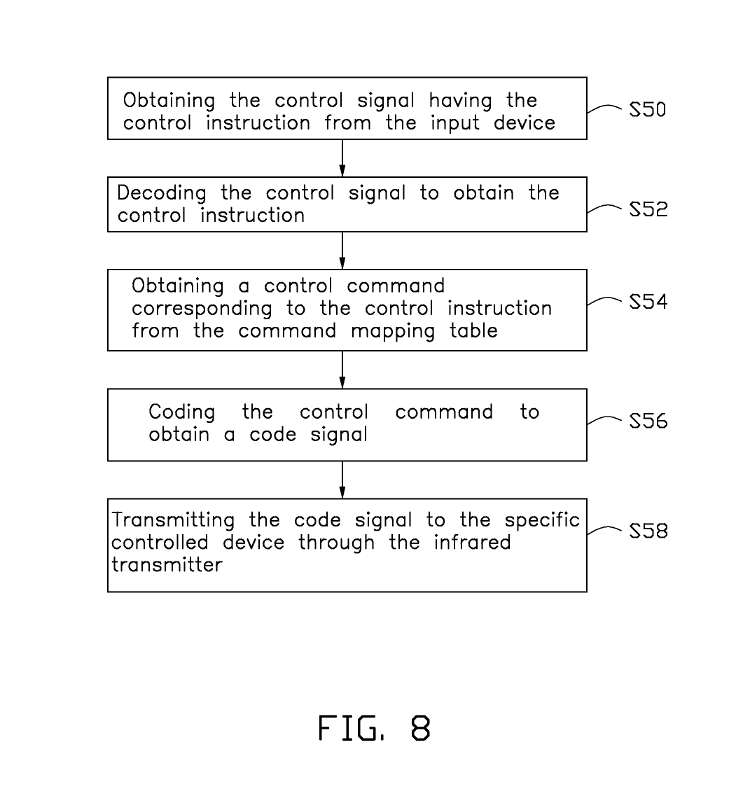

Referring to FIG. 8, in one embodiment, the step S6 further includes the following steps.

In step S50, the network detection unit 114 obtains the control signal having the control instruction from the input device 500.

In step S52, the first decode unit 112 decodes the control signal to obtain the control instruction.

In step S54, the first decode unit 112 obtains a control command corresponding to the control instruction from the command mapping table 122.

In step S56, the first decode unit 110 codes the control command to obtain a code signal.

In step S58, the infrared transmitting unit 113 transmits the code signal to the specific controlled device 40 through the infrared transmitter 106.

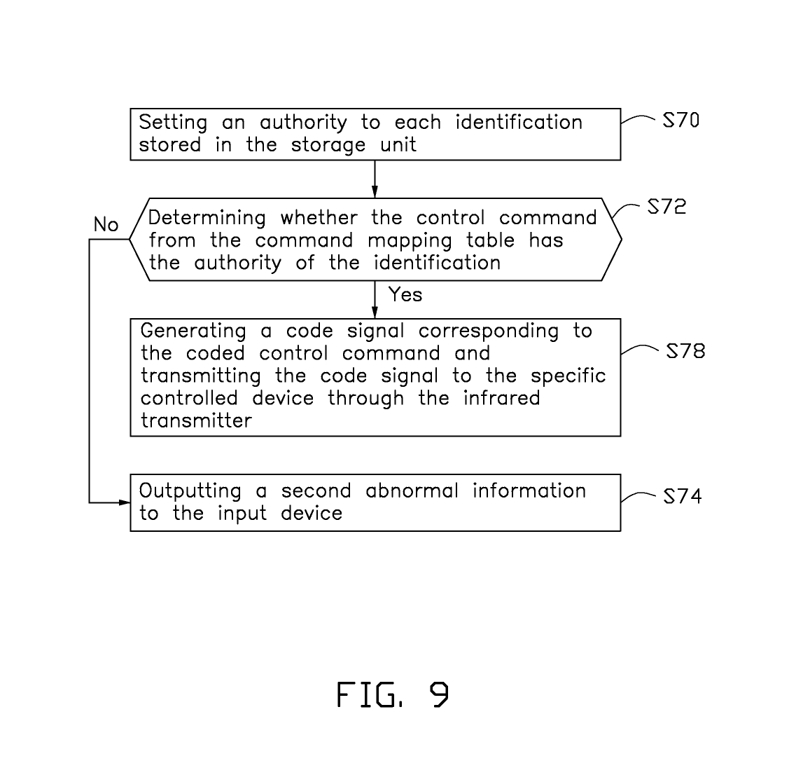

Referring to FIG. 9, in one embodiment, the remote control method further includes the following steps between step S54 and step S56.

In step S70, the authority setting unit 118 sets an authority to each identification stored in the storage unit 102.

In step S72, the authority setting unit 118 determines whether the control command from the command mapping table 122 has the authority of the identification. If yes, step S56 is performed; if not, step S74 is performed.

In step S74, the anomaly process unit 115 outputs a second abnormal information to the input device 500.

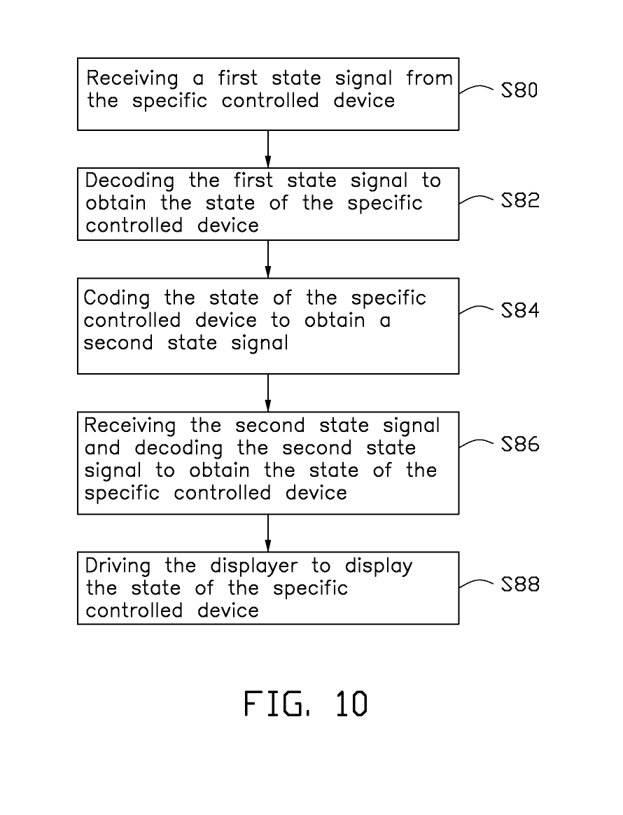

Referring to FIG. 10, in one embodiment, step S7 further includes the following steps.

In step S80, the infrared receiving unit 119 receives a first state signal from the specific controlled device 40.

In step S82, the first decode unit 112 decodes the first state signal to obtain the state of the specific controlled device 40.

In step S84, the first code unit 110 codes the state of the specific controlled device 40 into a second state signal.

In step S86, the second decode unit 237 receives the second state signal and decodes the second state signal to obtain the state of the specific controlled device 40.

In step S88, the display drive unit 239 drives the displayer 200 to display the state of the specific controlled device 40.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A data process device for remotely controlling controlled devices, comprising:
a first communication device for wirelessly communicating with an input device and receiving a control signal from the input device;
a storage unit storing an identification table;
a controller configured to determine whether the data process device receives a control signal from the input device through the first communication device, the control signal comprising an identification of the input device, wherein when receiving the control signal, the controller determines if the identification of the input device is stored in the identification table, the controller outputs a code signal corresponding to the control signal upon a condition that the identification of the input device is stored in the identification table; and
a transceiver configured to receive the code signal and transmit the code signal to a specific one of the controlled devices.

2. The data process device of claim 1, wherein the input device comprises smart devices and computer servers; the identification table stores identifications of the smart devices and the computer servers; the storage unit stores a priority table, the priority table stores an identification order; when there are at least two of the smart devices and the computer servers intending to control the same controlled device, the data process device performs the control signal output from one of the smart device and the computer servers having highest priority.

3. The data process device of claim 2, wherein the data process device sets an authority to each identification stored in the identification table; when receiving the control signal from the input device, the data process device determines whether the identification of the control signal has the authority; the data process device outputs the code signal corresponding to the control signal to the specific controlled device upon a condition that the identification of the control signal has the authority.

4. The data process device of claim 3, wherein the transceiver comprises an infrared transmitter; the storage unit stores a command mapping table; the controller comprises a network detection unit, an identification unit, a mode setting unit, an infrared transmitting unit, a decode unit, and a code unit; the mode setting unit is configured to set the working mode of the first communication device; when the network unit obtains the control signal through the first communication device, the identification unit outputs an authentication signal to the network detection unit if the identification unit determines that the identification of the input device is stored in the identification table, the network detection unit obtains the control signal and transmits the control signal to the decode unit, the decode unit decodes the control signal to obtain a control instruction corresponding to the control signal and obtains a control command corresponding to the control instruction from the command mapping table and then transmits the control command to the code unit, the code unit codes the control command into the code signal and transmits the code signal to the infrared transmitting unit, the infrared transmitting unit transmits the code signal to the specific controlled device through the infrared transmitter.

5. The data process device of claim 4, wherein the controller comprises an authority setting unit, the authority setting unit is configured to determine whether there are at least two of the smart devices and the computer servers intending to control the same controlled device according to the identifications from the input device and the control commands corresponding to the control signals from the input device; the authority setting unit is also configured to determine whether there are at least two of the smart devices and the computer servers intending to control the same function of the same controlled device according to the identifications from the input device and the control commands corresponding to the control signals from the input device.

6. The data process device of claim 5, wherein the data process device comprises a second communication device, the second communication device comprises a cable network unit, the first communication comprises an NFC sensor, a BLUETOOTH adapter, and a wireless network unit; when the network detection unit determines that the input device is not connecting to the cable network unit, the network detection unit further determines if the input device intends to connect to any one of the NFC sensor, the BLUETOOTH adapter and the wireless network unit.

7. The data process device of claim 6, wherein the controller comprises an anomaly process unit; when the identification unit determines that the identification from the input device is not stored in the storage unit, the identification unit outputs a first abnormal signal to the anomaly process unit, and then the anomaly process unit outputs a first abnormal information to the input device.

8. The data process device of claim 7, wherein the authority setting unit is also configured to set an authority to each identification stored in the identification table; when the decode unit obtains the control command, the decode unit outputs the control command to the authority setting unit, the authority setting unit determines if the control command has the authority; when the control command has the authority, the authority setting unit outputs an authority signal to the code unit, and then the code unit codes the control command into the code signal; when the control command has no authority, the authority setting unit outputs a second abnormal signal to the anomaly process unit, and then the anomaly process unit outputs a second abnormal information to the input device.

9. The data process device of claim 8, wherein the controller comprises an infrared receiving unit, the transceiver comprises an infrared receiver, the infrared receiving unit is configured to receive a first state signal from the controlled devices through the infrared receiver and transmit the first state signal to the decode unit; when receiving the first state signal, the decode unit decodes the first state signal to obtain a state information and transmits the state information to the code unit, the code unit codes the state information to obtain a second state signal and transmits the second state signal to the input device.

10. A remote control method for remotely controlling controlled devices through a data process device, the method comprising:
obtaining an identification of an input device if the data process device communicates with the input device;
obtaining a control signal from the input device if the identification from the input device is matching;
decoding the control signal to obtain a control instruction;
obtaining a control command corresponding to the control instruction from a storage unit of the data process device;
coding the control command into a code signal; and
transmitting the code signal to a specific one of the controlled devices.

11. The method of claim 10, comprising:
reminding users to store the identification of the input device if the identification of the input device is not matching;
storing the identification of the input device in the storage unit if the users decide to store the identification of the input device; and
outputting a first abnormal information if the users decide not to store the identification of the input device.

12. The method of claim 10, wherein the data process device communicates with the input device through a cable communication network.

13. The method of claim 10, wherein the data process device communicates with the input device through a wireless communication network if there is no cable communication network between the data process device and the input device.

14. The method of claim 10, wherein if there are at least two control signals from the input device, the method comprises:
determining whether the at least two control signals intend to control the same controlled device; and
coding the control command corresponding to the identification having highest priority.

15. The method claim 14, wherein after obtaining a control command corresponding to the control instruction from a storage unit of the data process device, the method comprises:
determining whether the control command has an authority; and
outputting a second abnormal information to the input device if the control command has no authority.

16. A remote control system for remotely controlling controlled devices, comprising:
an input device comprising a first communication device; and
a data process device, comprising :
a second communication device configured to communicate with the first communication device;
a storage unit storing an identification table;
a controller configured to determine whether the data process device receives a control signal from the input device, the control signal comprising an identification of the input device, wherein when receiving the control signal, the controller determines if the identification of the input device is stored in identification table, the controller outputs a code signal corresponding to the control signal upon a condition that the identification of the input device is stored in the storage unit; and
a transceiver configured to receive the code signal and transmit the code signal to a specific one of the controlled devices.

17. The remote control system of claim 16, wherein when the identification from the input device is not stored in the identification table, the data process device outputs a reminder to the input device, so as to remind users whether to store the identification from the input device in the identification table; when the users decide to store the identification from the input device in the identification table, the controller stores the identification from the input device in the identification table; when the users decide not to store the identification from the input device in the identification table, the data process device outputs a first abnormal information to the input device.

18. The remote control system of claim 16, wherein the storage unit stores a priority table, the priority table stores an identification order; when there are at least two control signals intending to control the same controlled device, the controller outputs the code signal corresponding to the control signal having highest priority by reading the priority table.

19. The remote control system of claim 16, wherein the data process device sets an authority to each identification stored in the identification table; when receiving the control signal from the input device, the data process device determines whether the identification of the control signal has the authority; the data process device outputs the code signal corresponding to the control signal to the specific controlled device upon a condition that the identification of the control signal has the authority; the data process device outputs a second abnormal information to the input device upon a condition that the identification of the control signal has no authority.

20. Apparatus for using an input device to remotely control multiple devices each remotely controllable by an infrared remote controller, said apparatus comprising:
a data interface for receiving control commands from the input device, the control commands specifying remotely controlled operations to be performed by selected ones of the multiple devices;
an infrared transmitter for sending remote control codes to selected ones of the multiple devices for remote control of the multiple devices to perform the remotely controlled operations; and
a storage unit storing mapping information providing mappings between the control commands for specifying the remotely controlled operations and corresponding ones of the remote control codes that can be sent to the multiple devices for remote control of the multiple devices to perform the remotely controlled operations;
wherein the storage unit is coupled to the data interface to receive one of the control commands specifying a selected one of the remotely controlled operations to be performed by a selected one of the multiple devices and to recall the mapping information specifying the remote control code corresponding to said one of the control commands, and the storage unit is coupled to the infrared transmitter to send the remote control code corresponding to said one of the control commands to the infrared transmitter to transmit the remote control code corresponding to said one of the control commands to the selected one of the multiple devices to perform said selected one of the remotely controlled operations.
